(19) United States
(12) Patent Application Publication
(10) Pub. No.: US 2023/0397572 A1
(43) Pub. Date: Dec. 14, 2023

(54) Vacuum Feeder

(71) Applicant: SHENZHEN UAH TECHNOLOGY CO., LTD, Shenzhen (CN)

(72) Inventors: Qiang Geng, Shenzhen (CN); Shengbo Lu, Shenzhen (CN)

(21) Appl. No.: 17/881,585

(22) Filed: Aug. 4, 2022

(30) Foreign Application Priority Data
Jun. 9, 2022 (CN) 202210647061.1

(51) Int. Cl. A01K 5/02

(52) U.S. Cl. CPC A01K 5/0225

(57) ABSTRACT

The present application belongs to the technical field of pet feeders, in particular to a vacuum feeder. The vacuum feeder comprises a vacuum extractor, a food outlet hose, a seal and drive assembly and an outer barrel provided with a food storage space and an installation space; the vacuum extractor, the food outlet hose and the seal and drive assembly are all installed in the installation space, and the vacuum extractor is used for vacuumizing the food storage space to a vacuum state, the food storage space is communicated with an inlet of the food outlet hose, and the seal and drive assembly is used for pressing and sealing the food outlet hose. According to the application, when the food storage space is in a vacuum state, the food outlet hose is sealed, thus ensuring airtightness, preventing food from being contaminated, ensuring safety of the food and prolonging storage time.

### CROSS REFERENCE TO RELATED APPLICATIONS

The present application claims the benefit of Chinese Patent Application No. 202210647061.1 filed on Jun. 9, 2022, the contents of which are incorporated herein by reference in their entirety.

### TECHNICAL FIELD

The present application belongs to the technical field of pet feeders, in particular to a vacuum feeder.

### BACKGROUND

With the development of social economy and the acceleration of urbanization, more and more people like to live in their own small circles, and their interpersonal communication is becoming less and less. Pets such as cats and dogs can be people's friendly companions. These pets can not only help people get rid of loneliness in life, but also adjust people's mental health. And, for some elderly people who live alone, pets are their life partners. Keeping pets is beneficial to the physical and mental health of the elderly, and the life of the elderly can be fulfilling and enriched through communication with pets.

Pet keeping requires daily food feeding, but in daily life, most office workers often can't take good care of their pets' daily meals at home, or people can't take care of their pets when they go on business trips or travel occasionally. In this case, the smart feeder came into being, and people can remotely control the smart feeder to pour out the food for pets to eat.

In the prior art, in order to avoid bacterial infection of food in the smart feeder, a vacuum extractor is arranged in the intelligent feeder, and the vacuum extractor is used to extract the storage space in the intelligent feeder into a vacuum state. However, the existing smart feeder has some problems, such as poor sealing effect, complex structure and high manufacturing cost.

### SUMMARY

The present application provides a vacuum feeder, aiming at solving the technical problems of poor sealing effect, complex structure and high manufacturing cost of the existing smart feeder.

In order to solve the above problems, embodiments of the present application provides a vacuum feeder, including a vacuum extractor, a food outlet hose, a seal and drive assembly and an outer barrel provided with a food storage space and an installation space; the vacuum extractor, the food outlet hose and the seal and drive assembly are all installed in the installation space, and the vacuum extractor is used for vacuumizing the food storage space to a vacuum state, the food storage space is communicated with an inlet of the food outlet hose, and the seal and drive assembly is used for pressing and sealing the food outlet hose;

when receiving a vacuumizing instruction, after the food outlet hose is pressed and sealed by the seal and drive assembly, the food storage space is vacuumized to the vacuum state by the vacuum extractor; and when receiving a feeding instruction, the sealed food outlet hose is opened by the seal and drive assembly, so that food in the food storage space is transported from the food outlet hose.

Optionally, the seal and drive assembly includes an abutment rod, a linear drive part and a pressing rod installed at an output end of the linear drive part; the abutment rod and the linear drive part are both installed in the installation space, and the food outlet hose is positioned between the abutment rod and the pressing rod; the linear drive part is used for driving the pressing rod to move relative to the abutment rod, so as to seal the food outlet hose between the abutment rod and the pressing rod, or to open the food outlet hose.

Optionally, the seal and drive assembly further includes a guide part installed in the installation space, the guide part is provided with a slide hole, and one end of the pressing rod extends into the slide hole.

Optionally, the outer barrel includes a food storage barrel provided with the food storage space and an installation barrel provided with the installation space; the food storage barrel is detachably installed on the installation barrel, the installation barrel is further provided with a connecting hole, and the inlet of the food outlet hose is communicated with the connecting hole.

Optionally, the vacuum feeder further includes a stirring and transporting part and a separator provided with a food outlet through hole; the separator is installed in the food storage space, and the separator divides the food storage space into an upper space and a lower space, the upper space is communicated with the lower space through the food outlet through hole, and the connecting hole is communicated with the lower space; and
the stirring and transporting part includes a rotation drive part and a rotation fan installed on an output shaft of the rotation drive part, and the rotation fan is positioned in the lower space; the rotation fan is provided with food storage cavities distributed at intervals, and the rotation drive part is used for driving the rotation fan to transport food in the food storage cavity to the connecting hole.

Optionally, the stirring and transporting part further includes a stirring fan installed on the output shaft of the rotation drive part, the stirring fan is positioned in the upper space; and the rotation drive part is also used for driving the stirring fan to stir food in the upper space.

Optionally, the outer barrel further includes a cover and a sealing ring, the cover is provided with an annular groove, the sealing ring is installed in the annular groove, and the cover covers the opening of the food storage barrel through the annular groove.

Optionally, the vacuum extractor includes a vacuum pump, a three-way pipe and a pneumatic valve for detecting a pressure value of the food storage space, and the three-way pipe is provided with a first nozzle, a second nozzle and a third nozzle, these three nozzles are interconnected; an air inlet of the vacuum pump is communicated with the first nozzle, the second nozzle is communicated with a detection port of the pneumatic valve, and the third nozzle is communicated with the food storage space; and
when the pneumatic valve detects that the pressure value of the food storage space is less than a first preset negative pressure value, the vacuum pump is controlled to stop vacuumizing the food storage space.

Optionally, the outer barrel is further provided with a connector communicating with the food storage space; the vacuum extractor further includes a flexible joint and a one-way valve, the third nozzle is communicated with an outlet of the one-way valve, and an inlet of the one-way valve is communicated with the connector through the food outlet hose.

Optionally, the vacuum feeder further includes a feeding dish, and the feeding dish is arranged opposite to an outlet of the food outlet hose.

According to the invention, when a vacuumizing instruction is received, the food outlet hose is squeezed and sealed by the seal and drive assembly, and then the food storage space is pumped into a vacuum state by the vacuum extractor; Specifically, after receiving the vacuumizing instruction, the seal and drive assembly squeezes the food outlet host so that the inner wall surfaces of both sides of the food outlet host are mutually attached (that is, the food outlet host is sealed), and then the vacuum extractor evacuates the food storage space into a vacuum state. According to the application, when the food storage space is in a vacuum state, the food outlet hose is sealed, thus ensuring the airtightness of the food storage space, preventing food in the food storage space from being contaminated with bacteria in the air, ensuring safety of the food and prolonging the storage time of the food.

When receiving a feeding instruction, the sealed food outlet hose is opened by the seal and drive assembly, so that food in the food storage space is transported from the food outlet hose. Specifically, after receiving the feeding instruction, the seal and drive assembly moves away from the food outlet host, and the food outlet host would automatically return to the opening state, so that the food in the food storage space would be automatically transported through the food outlet host, and thus, the vacuum feeder completes the feeding work for the pet. According to the present application, the seal and drive assembly presses the food outlet hose to realize the sealing of the vacuum feeder. The vacuum feeder has the advantages of simple structure and low manufacturing cost.

### BRIEF DESCRIPTION OF THE DRAWINGS

The present application is further illustrated with reference to the following drawings and embodiments.

FIG. 1 is a structural schematic diagram of a vacuum feeder provided by an embodiment of the present application;

FIG. 2 is a structural schematic diagram of an vacuum assembly, a seal and drive assembly and a food outlet hose of a vacuum feeder provided by an embodiment of the present application;

FIG. 3 is a partial structural diagram of a vacuum feeder provided by an embodiment of the present application;

FIG. 4 is a structural schematic diagram of a food storage barrel of a vacuum feeder and components installed on the food storage barrel provided by an embodiment of the present application;

FIG. 5 is a sectional view of FIG. 4;

FIG. 6 is a structural schematic diagram of a stirring and transporting part of a vacuum feeder provided by an embodiment of the present application;

FIG. 7 is a structural schematic diagram of an installation barrel of a vacuum feeder and its internal components provided by an embodiment of the present application.

Reference signs in the figures are as follows:

1. Vacuum extractor; 11. Vacuum pump; 12. Three-way pipe; 13. Pneumatic valve; 14. Flexible joint; 15. One-way valve; 2. Food outlet hose; 3. Seal and drive assembly; 31. Abutment rod; 32. Linear drive part; 33. Pressing rod; 34. Guide part; 341. Slide hole; 4. Outer barrel; 41. Food storage barrel; 411. Food storage space; 4111. Upper space; 4112. Lower space; 42. Installation barrel; 421. Installation space; 43. Stirring and transporting part; 431. Rotation drive part; 432. Rotation fan; 4321. Food storage cavity; 433. Stirring fan; 44. Separator; 441. Food outlet through hole; 45. Cover; 46. Connector; 5. Feeding dish.

### DETAILED DESCRIPTION OF DISCLOSED EMBODIMENTS

In order to make the beneficial effects, technical solutions and technical problems solved by the present application clearer, the present application will be further illustrated in detail with reference to the drawings and embodiments. It should be understood that the specific embodiments described here are merely for illustrating the present application, but not for limiting the present application.

It should be understood that the directions or positional relationships indicated by the terms “upper”, “lower”, “left”, “right”, “front”, “back” and “middle” are based on the directions or positional relationships shown in the drawings, only for convenience of describing the present application and simplifying the descriptions, instead of indicating or implying that the device or element must have a specific orientation, be constructed or operated in a specific orientation, and therefore cannot be understood as a limitation of the present application.

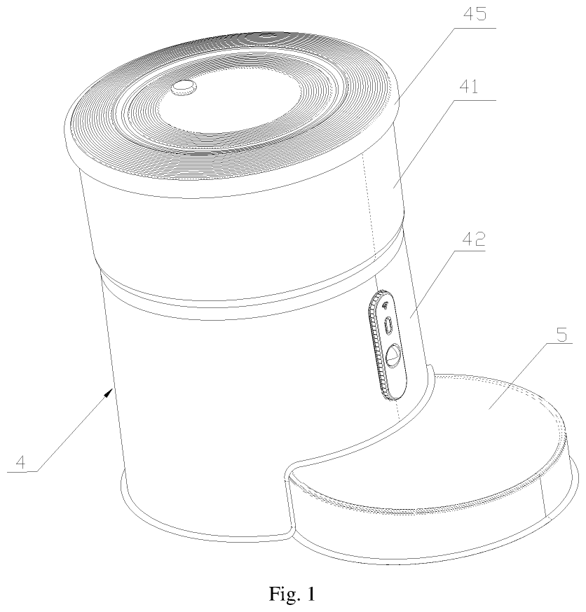

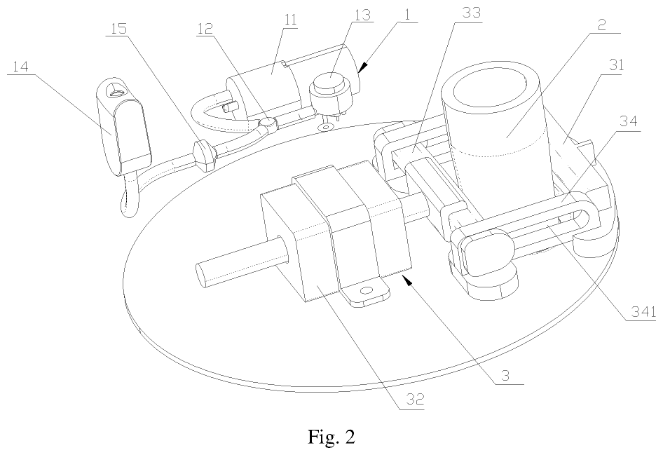

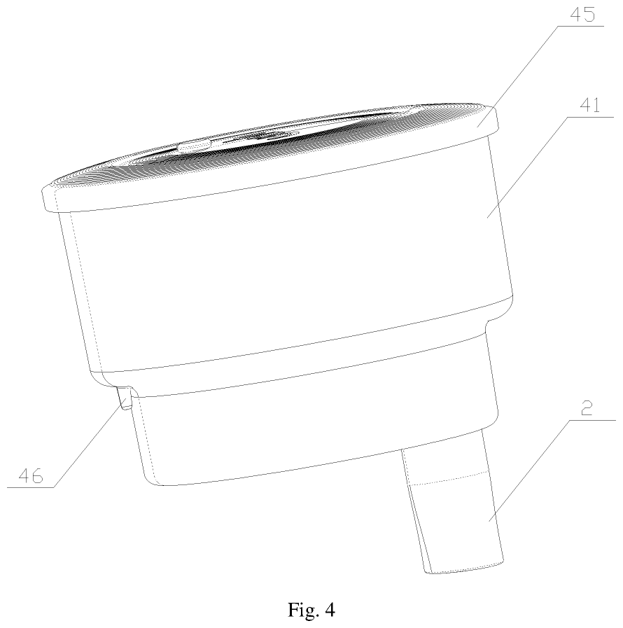

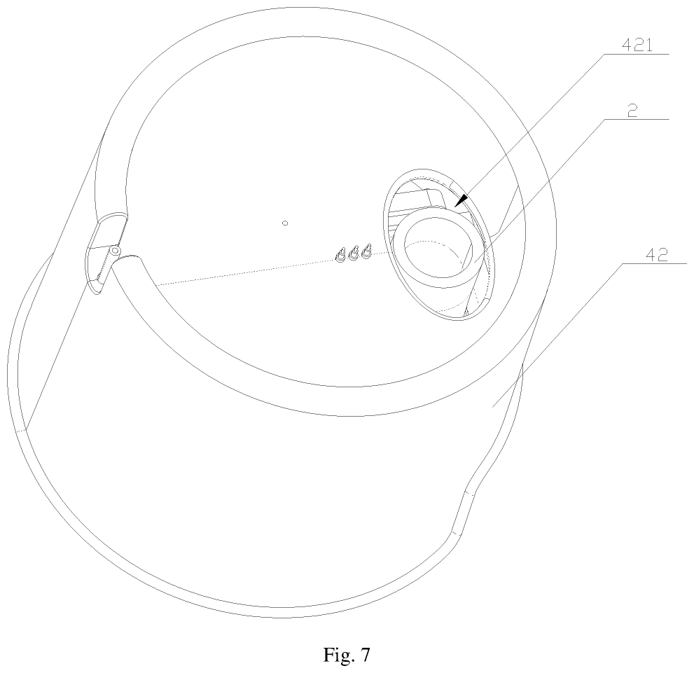

As shown in FIG. 1, FIG. 2, FIG. 4 and FIG. 7, a vacuum feeder provided by an embodiment of the present application includes a vacuum extractor 1, a food outlet hose 2, a seal and drive assembly 3 and an outer barrel 4 provided with a food storage space 411 and an installation space 421. The vacuum extractor 1, food outlet hose 2 and seal and drive assembly 3 are all installed in the installation space 421, and the vacuum extractor 1 is used for pumping the food storage space 411 to a vacuum state, the food storage space 411 is communicated with the inlet of the food outlet hose 2, and the seal and drive assembly 3 is used for pressing and sealing the food outlet hose 2. Understandably, the food outlet hose 2 may be made of flexible plastic, soft glue, silica gel and other materials. The seal and drive assembly 3 seals the food outlet hose 2 by compression; that is, when the seal and drive assembly 3 drives the inner side walls of both sides of the food outlet hose 2 to attach to each other, the food outlet hose 2 is sealed, so that the food outlet hose 2 does not communicate with the external environment; when the seal and drive assembly 3 does not press the food outlet hose 2, or the seal and drive assembly 3 presses the food outlet hose 2, but the food outlet hose 2 is not sealed, the food storage space 411 communicates with the external environment through the food outlet hose 2.

In the present application, the outer barrel 4 is provided with a food storage space 411 and an installation space 421 which are distributed at intervals, and the food storage space 411 can store food for a long time. The installation space 421 can be used for installation of the vacuum extractor 1, seal and drive assembly 3 and other components, so as to prevent the food in the food storage space 411 from interfering with the components in the installation space 421.

Upon receiving a vacuumizing instruction, the food outlet hose 2 is pressed and sealed by the seal and drive assembly 3, and then the food storage space 411 is evacuated into vacuum by the vacuum extractor 1. Understandably, the vacuumizing instruction may be an instruction issued by a user through a mobile terminal such as a mobile phone or a tablet, or an instruction automatically issued by a control panel through its own program (for example, the vacuumizing instruction automatically issued by a control panel after the vacuum feeder transports food and closes the food outlet hose 2). Specifically, after receiving the vacuumizing instruction, the seal and drive assembly 3 presses the food outlet hose 2 so that the inner wall of both sides of the food outlet hose 2 are attached to each other (i.e., the food outlet hose 2 is sealed), and then the vacuum extractor 1 evacuates the food storage space 411 into a vacuum state. According to the application, when the food storage space 411 is in a vacuum state, the food outlet hose 2 is sealed, thus ensuring the airtightness of the food storage space 411, preventing food in the food storage space 411 from being contaminated with bacteria in the air, ensuring safety of the food and prolonging the storage time of the food.

when receiving a feeding instruction, the sealed food outlet hose 2 is opened by the seal and drive assembly 3, so that food in the food storage space 4 is transported from the food outlet hose 2. Understandably, the feeding instruction may be an instruction issued by a user after performing related operations through terminal devices such as mobile phones and tablets, or an instruction issued by a control panel according to its own program (such as a timed feeding instruction, etc.). Specifically, after receiving the feeding instruction, the seal and drive assembly 3 moves away from the food outlet host 2, and the food outlet host 2 would automatically return to the opening state, so that the food in the food storage space 411 would be automatically transported through the food outlet host 2, and thus, the vacuum feeder completes the feeding work for the pet. According to the present application, the seal and drive assembly 3 presses the food outlet hose 2 to realize the sealing of the vacuum feeder. The vacuum feeder has the advantages of simple structure and low manufacturing cost.

In an embodiment, as shown in FIG. 2, the seal and drive assembly 3 includes an abutment rod 31, a linear drive part 32, and a pressing rod 33 installed at the output end of the linear drive part 32. The abutment rod 31 and the linear drive part 32 are both installed in the installation space 421, and the food outlet hose 2 is positioned between the abutment rod 31 and the pressing rod 33. The linear drive part 32 is used to drive the pressing rod 33 to move relative to the abutment rod 31, so as to seal the food outlet hose 2 between the abutment rod 31 and the pressing rod 33, or to open the food outlet hose 2. Understandably, the linear drive part 32 includes, but is not limited to, linear motors, pneumatic cylinders, hydraulic cylinders, screw and nut mechanisms and other devices. The outlet of the food outlet hose 2 extends to the external environment after passing through the compression space between the pressing rod 33 and the abutment rod 31. The abutment rod 31 and the linear drive part 32 are both fixedly installed on the bottom plate of the outer barrel 4.

Specifically, when receiving the vacuumizing instruction, the linear drive part 32 drives the pressing rod 33 to move toward the abutment rod 31 until the pressing rod 33 flattens and seals the food outlet hose 2.

Upon receiving the feeding instruction, the linear drive part 32 drives the pressing rod 33 to move toward the end away from the abutment rod 31 until the sealed food outlet hose 2 is opened. In this embodiment, the seal and drive assembly 3 has the advantages of simple structure, low manufacturing cost and small occupied space.

In an embodiment, as shown in FIG. 2, the seal and drive assembly 3 further includes a guide part 34 installed in the installation space 421, the guide part 34 is provided with a slide hole 341, and one end of the pressing rod 33 extends into the slide hole 341. Understandably, the slide hole 341 is an elongated through hole, the length direction of the elongated through hole is parallel to the moving direction of the pressing rod 33. Specifically, there are two guide parts 34, and the opposite ends of the pressing rod 33 are respectively inserted into the slide hole 341 of the two guide parts 34. In this embodiment, the design of the guide part 34 ensures the stability of the pressing rod 33 pressing the food outlet hose 2.

In another embodiment, the seal and drive assembly 3 includes a bidirectional driver (not shown), a first pressing rod (not shown) and a second pressing rod (not shown), wherein the first pressing rod is installed at the first output end of the bidirectional driver, The second pressing rod is installed at the second output end of the bidirectional driver, and the bidirectional driver is used for driving the first pressing rod and second pressing rod to approach or move away from each other to seal or open the food outlet hose 2.

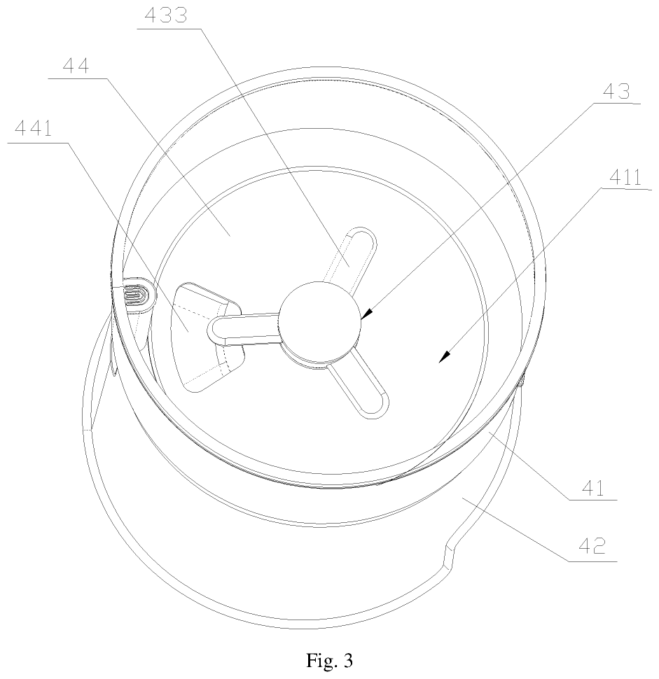

In an embodiment, as shown in FIGS. 3, 4 and 7, the outer barrel 4 includes a food storage barrel 41 provided with the food storage space 411 and an installation barrel 42 provided with the installation space 421. The food storage barrel 41 is detachably installed on the installation barrel 42, and the installation barrel 42 is also provided with a connecting hole, and the inlet of the food outlet hose 2 is communicated with the connecting hole. Understandably, the food storage barrel 41 is detachably installed above the installation barrel 42, and the food in the food storage space 411 is transported into the food outlet hose 2 through the connecting hole. In a specific embodiment, the outer barrel 4 is provided with a connector, the connector is provided with the connecting hole, and the inlet of the food outlet hose 2 is sleeved on the connector, thus facilitating the disassembly of the food outlet hose 2 and the outer barrel 4.

In a specific embodiment, the installation barrel 42 is further provided with an accommodating groove, and the food storage barrel 41 is installed in the accommodating groove.

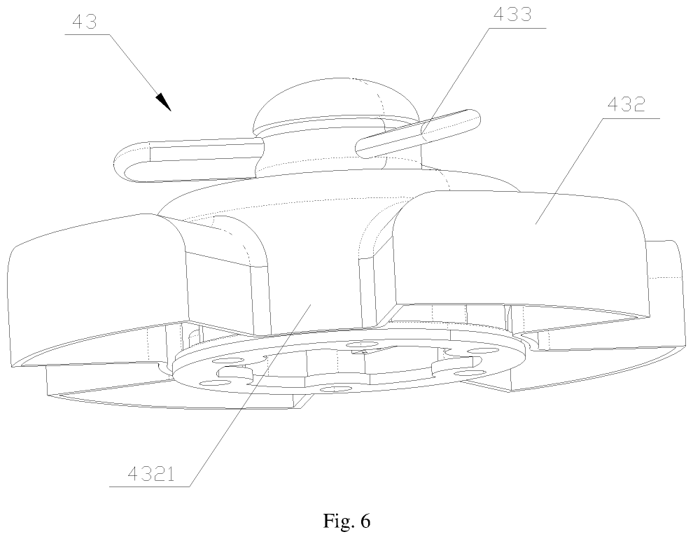

In an embodiment, as shown in FIGS. 4 to 6, the vacuum feeder further includes a stirring and transporting part 43 and a separator 44 provided with a food outlet through hole 441; the separator 44 is installed in the food storage space 411, and the separator 44 divides the food storage space 411 into an upper space 4111 and a lower space 4112, the upper space 4111 communicates with the lower space 4112 through the food outlet through hole 441, and the connecting hole communicates with the lower space 4112. Understandably, the connecting hole is arranged at the bottom of the lower space 4112; in the vertical direction, the food outlet through hole 441 is staggered from the connecting hole; the upper space 4111 can store food for a long time.

The stirring and transporting part 43 includes a rotation drive part 431 and a rotation fan 432 installed on the output shaft of the rotation drive part 431, and the rotation fan 432 is positioned in the lower space 4112; the rotation fan 432 is provided with food storage cavities 4321 distributed at intervals, and the rotation drive part 431 is used for driving the rotation fan 432 to transport the food in the food storage cavity 4321 to the connecting hole. Understandably, the food storage cavity 4321 has an up-down opening structure, the upper end of the food storage cavity 4321 abuts against the separator 44, and the lower end of the food storage cavity 4321 abuts against the bottom of the lower space 4112. Specifically, the food in the upper space 4111 is transported to the food storage cavity 4321 through the food outlet through hole 441, and the rotation drive part 431 drives the rotation fan 432 to rotate, when the food storage cavity 4321 with food is rotated above the connecting hole, the food in the food storage cavity 4321 would be transported into the food outlet hose 2 through the connecting hole. In this embodiment, by controlling the number of turns that the rotation drive part 431 drives the rotation fan 432 to rotate, the amount of food to be fed can by controlled. And the vacuum feeder has the advantages of simple structure and low manufacturing cost.

In addition, both the rotation drive part 431 and rotation fan 432 are installed in the lower space 4112 of the food storage barrel 41, and the food storage barrel 41 and installation barrel 42 are detachably connected. Thereby facilitating cleaning and maintenance of the rotation drive part 431 and rotation fan 432.

In a specific embodiment, the rotation drive part 431 is fixed at the bottom of the lower space 4112 by fasteners (screws, etc.), and a sealing ring is arranged between the rotation drive part 431 and the bottom of the lower space 4112, which further ensures the sealing performance of the outer barrel 4.

In an embodiment, as shown in FIGS. 4 to 6, the stirring and transporting part 43 further includes a stirring fan 433 installed on the output shaft of the rotation drive part 431, and the stirring fan 433 is positioned in the upper space 4111; the rotation drive part 431 is further used to drive the stirring fan 433 to stir the food in the upper space 4111. Understandably, the output shaft of the rotation drive part 431 penetrates through the separator 44 and extends into the upper space 4111, and the rotation fan 432 is detachably mounted on the output shaft of the rotation drive part 431. In this embodiment, the rotation drive part 431 drives the stirring fan 433 to rotate, and the rotating stirring fan 433 can stir the food with larger particles in the upper space 4111 into fine particles. The food with fine particle is rotated above the food outlet through hole 441 by the stirring fan 433 and falls into the food storage cavity 4321. In the present application, the rotation drive part 431 can drive the stirring fan 433 and rotation fan 432 to rotate at the same time, thus improving the integration of the vacuum feeder.

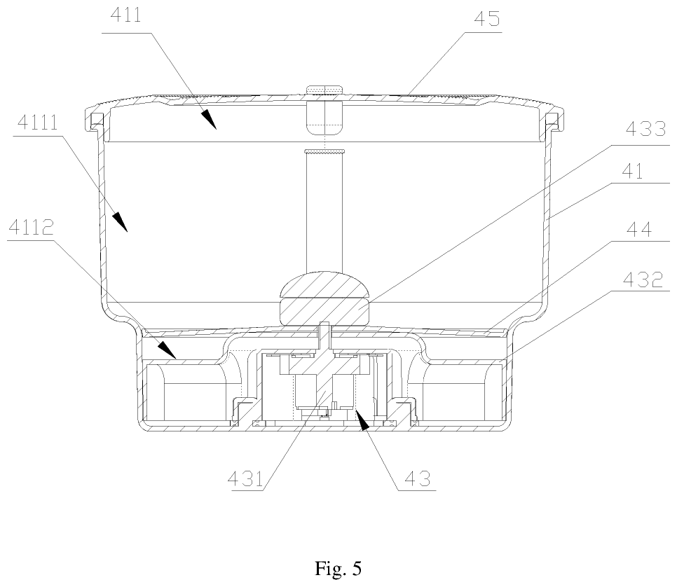

In an embodiment, as shown in FIGS. 4 and 5, the outer barrel 4 further includes a cover 45 and a sealing ring, wherein the cover 45 is provided with an annular groove in which the sealing ring is installed, and the cover 45 covers the opening of the food storage barrel 41 through the annular groove. Understandably, the upper end of the outer barrel 4 has an opening structure, and the cover 45 sealingly covers the opening of the food storage barrel 41 through the annular groove. And a sealing ring is arranged in the annular groove, thus ensuring the airtightness of the food storage barrel 41. In the present embodiment, when a user puts food into the upper space 4111, the cover 45 is first opened, and then the food is put into the upper space 4111.

Furthermore, as shown in FIG. 4 and FIG. 5, the cover 45 is provided with a pressure relief hole, and a pressure relief piece is installed in the pressure relief hole; the pressure relief piece may be a pressure relief valve, when the pressure in the upper space 4111 is less than or equal to a preset low-pressure limit, the pressure relief valve would automatically relieve the pressure. The pressure relief piece may also be a sealing plug, so that users can manually relieve the pressure of the food storage space 411 through the sealing plug.

In an embodiment, as shown in FIG. 2, the vacuum extractor 1 includes a vacuum pump 11, a three-way pipe 12 and a pneumatic valve 13 for detecting the pressure value in the food storage space 411, and the three-way pipe 12 is provided with a first nozzle, a second nozzle and a third nozzle which are communicated with each other. The air inlet of the vacuum pump 11 is connected with the first nozzle, the second nozzle is connected with the detection port of the pneumatic valve 13, and the third nozzle is connected with the food storage space 411. Understandably, the air outlet of the vacuum pump 11 is connected with the external environment through a pipeline. As the food storage space 411 is communicated with the three-way pipe 12, the pneumatic valve 13 can detect the pressure value in the food storage space 411 in real time through the third nozzle. The pneumatic valve 13 is installed in the installation space 421, and it is at atmospheric pressure, so that it is convenient to detect the pressure value of the food storage space 411.

when the pneumatic valve 13 detects that the pressure value of the food storage space 411 is less than a first preset negative pressure value, the vacuum pump 11 is controlled to stop vacuumizing the food storage space 411. Understandably, the first preset negative pressure value may be set according to actual requirements, for example, the first preset negative pressure value is −20 pa, −25 pa or −15 pa, etc. In a specific embodiment, the first preset pressure value is −20 pa. When the pneumatic valve 13 detects that the pressure value in the food storage space 411 is less than −20 pa (e.g., the pressure in the food storage space 411 is −21 pa), the vacuum pump 11 is controlled to stop vacuumizing the food storage space 411, so as to avoid the accident that the vacuum feeder is damaged due to excessive negative pressure in the food storage space 411, and ensure the safety of the vacuum feeder.

Further, when the pneumatic valve 13 detects that the pressure value in the food storage space 411 is greater than a second preset negative pressure value, the vacuum pump 11 is controlled to vacuumize the food storage space 411 until the pressure value in the food storage space 411 is less than the first preset negative pressure value. Wherein the second preset negative pressure value is greater than the first preset negative pressure value; for example, the second preset negative pressure value is −10 pa, and the first preset negative pressure value is −20 pa. Understandably, in the sealing state of the food outlet hose 2, the food storage barrel 41 may be inevitably slightly leaked. When the pneumatic valve 13 detects that the pressure value (e.g., −9 pa) in the food storage space 411 is greater than the second preset pressure value, the vacuum pump 11 is automatically controlled to vacuumize the food storage space 411 until the pneumatic valve 13 detects that the pressure value in the food storage space 411 is less than the first preset negative pressure value. Therefore, the pressure value in the food storage space 411 is always kept in an appropriate negative pressure range (i.e., the pressure value in the food storage space 411 is larger than the first preset negative pressure value and smaller than the second preset negative pressure value), thus further ensuring the safety of food in the food storage space 411.

In an embodiment, as shown in FIG. 2, the outer barrel 4 is further provided with a connector 46 communicating with the food storage space 411. And the vacuum extractor 1 further includes a flexible joint 14 and a one-way valve 15. The third nozzle communicates with the outlet of the one-way valve 15, and the inlet of the one-way valve 15 communicates with the connector 46 through the food outlet hose 2. Understandably, the connector 46 is arranged at the lower end of the food storage barrel 41, the one-way valve 15 communicates with the flexible joint 14 through an air pipe, and the connector 46 is inserted into the through hole of the flexible joint 14. In this embodiment, the third nozzle is connected to the connector 46 through the one-way valve 15 and the flexible joint 14, and the vacuum pump 11 can pump the air in the food storage space 411 through the one-way valve 15. However, outside air cannot enter the food storage space 411 through the one-way valve 15, thus ensuring that the food storage space 411 is kept in a vacuum state. And the food storage space 411, one-way valve 15 and three-way pipe 12 are in communication, so that the pneumatic valve 13 can detect the pressure value of the food storage space 411 in real time through the third nozzle of the three-way pipe 12. In addition, the one-way valve 15 is connected to the connector 46 through the flexible joint 14, so that the disassembly between the flexible joint 14 and the connector 46 is simple, thus facilitating disassembly and assembly of the food storage barrel 41 and the installation barrel 42.

In an embodiment, as shown in FIG. 1, the vacuum feeder further includes a feeding dish 5, which is arranged opposite to the outlet of the food outlet hose 2. Understandably, the feeding dish 5 is positioned below the outlet of the food outlet hose 2, and the food transported from the food outlet hose 2 would drop into the feeding dish 5, so that pets can eat the food in the feeding dish 5.

The above are only preferred embodiments of the vacuum feeder of the present application and are not intended to limit the present application. Any modifications, equivalent substitutions and improvements made within the spirit and principle of the present application shall be included in the protection scope of the present application.

What is claimed is:

1. A vacuum feeder, comprising a vacuum extractor, a food outlet hose, a seal and drive assembly and an outer barrel provided with a food storage space and an installation space; the vacuum extractor, the food outlet hose and the seal and drive assembly are all installed in the installation space, and the vacuum extractor is used for vacuumizing the food storage space to a vacuum state, the food storage space is communicated with an inlet of the food outlet hose, and the seal and drive assembly is used for pressing and sealing the food outlet hose;
when receiving a vacuumizing instruction, after the food outlet hose is pressed and sealed by the seal and drive assembly, the food storage space is vacuumized to the vacuum state by the vacuum extractor; and
when receiving a feeding instruction, the sealed food outlet hose is opened by the seal and drive assembly, so that food in the food storage space is transported from the food outlet hose.

2. The vacuum feeder of claim 1, wherein the seal and drive assembly comprises an abutment rod, a linear drive part and a pressing rod installed at an output end of the linear drive part; the abutment rod and the linear drive part are both installed in the installation space, and the food outlet hose is positioned between the abutment rod and the pressing rod; the linear drive part is used for driving the pressing rod to move relative to the abutment rod, so as to seal the food outlet hose between the abutment rod and the pressing rod, or to open the food outlet hose.

3. The vacuum feeder of claim 2, wherein the seal and drive assembly further comprises a guide part installed in the installation space, the guide part is provided with a slide hole, and one end of the pressing rod extends into the slide hole.

4. The vacuum feeder of claim 1, wherein the outer barrel comprises a food storage barrel provided with the food storage space and an installation barrel provided with the installation space; the food storage barrel is detachably installed on the installation barrel, the installation barrel is further provided with a connecting hole, and the inlet of the food outlet hose is communicated with the connecting hole.

5. The vacuum feeder of claim 4, wherein the vacuum feeder further comprises a stirring and transporting part and a separator provided with a food outlet through hole; the separator is installed in the food storage space, and the separator divides the food storage space into an upper space and a lower space, the upper space is communicated with the lower space through the food outlet through hole, and the connecting hole is communicated with the lower space; and
the stirring and transporting part comprises a rotation drive part and a rotation fan installed on an output shaft of the rotation drive part, and the rotation fan is positioned in the lower space; the rotation fan is provided with food storage cavities distributed at intervals, and the rotation drive part is used for driving the rotation fan to transport food in the food storage cavity to the connecting hole.

6. The vacuum feeder of claim 5, wherein the stirring and transporting part further comprises a stirring fan installed on the output shaft of the rotation drive part, the stirring fan is positioned in the upper space; and the rotation drive part is also used for driving the stirring fan to stir food in the upper space.

7. The vacuum feeder of claim 1, wherein the outer barrel further comprises a cover and a sealing ring, the cover is provided with an annular groove, the sealing ring is installed in the annular groove, and the cover covers the opening of the food storage barrel through the annular groove.

8. The vacuum feeder of claim 1, wherein the vacuum extractor comprises a vacuum pump, a three-way pipe and a pneumatic valve for detecting a pressure value of the food storage space, and the three-way pipe is provided with a first nozzle, a second nozzle and a third nozzle, these three nozzles are interconnected; an air inlet of the vacuum pump is communicated with the first nozzle, the second nozzle is communicated with a detection port of the pneumatic valve, and the third nozzle is communicated with the food storage space; and
when the pneumatic valve detects that the pressure value of the food storage space is less than a first preset negative pressure value, the vacuum pump is controlled to stop vacuumizing the food storage space.

9. The vacuum feeder of claim 8, wherein the outer barrel is further provided with a connector communicating with the food storage space; the vacuum extractor further comprises a flexible joint and a one-way valve, the third nozzle is communicated with an outlet of the one-way valve, and an inlet of the one-way valve is communicated with the connector through the food outlet hose.

10. The vacuum feeder of claim 1, wherein the vacuum feeder further comprises a feeding dish, and the feeding dish is arranged opposite to an outlet of the food outlet hose.
